(19) United States
(12) Patent Application Publication
(10) Pub. No.: US 2023/0074969 A1
(43) Pub. Date: Mar. 9, 2023

(54) COCOA COMPOSITION

(71) Applicant: CARGILL, INCORPORATED, Wayzata, MN (US)

(72) Inventors: Vanessa BAREY, Mouscron (BE); Stefan VERVLIET, Mouscron (BE)

(73) Assignee: CARGILL, INCORPORATED, Wayzata, MN (US)

(21) Appl. No.: 17/904,315

(22) PCT Filed: Feb. 18, 2021
(86) PCT No.: PCT/US2021/018477

§ 371 Date: Aug. 16, 2022

(30) Foreign Application Priority Data
Feb. 21, 2020 (EP) 20158678.1

(51) Int. Cl. A23G 1/44; A23G 1/36; A23G 1/40; A23G 1/48

(52) U.S. Cl. CPC A23G 1/44; A23G 1/36; A23G 1/40; A23G 1/48

(57) ABSTRACT

The present invention relates to a cocoa composition comprising less than 5 weight % of milk solids, characterized in that it comprises 0.5-15 weight % of a pea-based protein and 0.5-10 weight % of a plasticizer ingredient. Also provided are food products comprising the cocoa composition described, for example bakery products, confectionary products, and dairy-alternative products.

### CROSS-REFERENCE TO RELATED APPLICATIONS

This application claims the benefit of European Patent Application No. 20158678.1, filed Feb. 21, 2020, which is hereby incorporated by reference herein in its entirety.

### FIELD OF THE INVENTION

The invention relates to a cocoa composition that is low in milk solids, comprising a plant-based protein and a plasticizer ingredient, said composition having a sensorial quality comparable to that of milk chocolate. The invention further relates to food products comprising the cocoa composition according to the invention.

### BACKGROUND OF THE INVENTION

Chocolate flavour is one of the most popular flavors in the world, with many foodstuffs incorporating chocolate or cocoa-derived ingredients in some fashion. Chocolate confectionary covers a wide range of sweet food products based on cocoa-derived ingredients, such as chocolate, cocoa-based coatings or couvertures, and cocoa-based fillings. Chocolate is especially popular for its typical fast melting in the mouth resulting in an explosion of bitter-sweet cocoa taste. Many chocolate confectionary recipes also contain in addition to the cocoa-derived ingredients milk solids to give an extra dimension of creaminess and milky taste.

However, despite its appeal, milk chocolate contains significant amounts of butter fat, milk protein and lactose. As a result, milk chocolate cannot be consumed by those suffering from lactose intolerance or milk allergies. It will also be undesirable for those following a vegan diet or avoiding dairy for religious or lifestyle reasons.

Past attempts to replace milk solids in milk chocolate have resulted in a chocolate of poor sensorial quality that is brittle, not snappy and lacks the typical creamy mouthfeel and flavour of traditional milk chocolate.

Thus, there remains a need for a chocolate product reduced in milk solids with an improved quality and eating sensation.

### SUMMARY OF THE INVENTION

The present invention relates to a cocoa composition comprising less than 5 weight % of milk solids, based on the total weight of the composition, characterized in that it further comprises 0.5-15 weight % pea protein and 0.5-10 weight % of a plasticizer ingredient.

The present invention also relates to a food product comprising such a composition, characterized in that the food product is, for example, a bakery or confectionary product.

### DETAILED DESCRIPTION

Unless otherwise specified herein, all weights are expressed as a percentage, by weight, relative to the total weight of the cocoa composition.

The present invention relates to a cocoa composition comprising less than 5 weight % of milk solids, characterized in that it comprises 0.5-15 weight % pea protein and 0.5-10 weight % of a plasticizer ingredient.

### Cocoa Composition

The term “cocoa composition” as referred to herein shall refer to a substantially homogeneous and fat-continuous composition, comprising at least some cocoa solids, and wherein the fat is preferably selected from the group consisting of cocoa butter, cocoa butter replacers, cocoa butter equivalents, cocoa butter improvers, cocoa butter substitutes and mixtures of two or more thereof. According to a particular aspect of the invention, the cocoa composition will be selected from the group consisting of a chocolate composition, a chocolate coating (or couverture) composition and a chocolate compound composition. It will typically comprise, in addition to the continuous fat phase, non-fatty cocoa solids, sugar and/or sugar replacers, and one or more optional ingredients such as emulsifiers and flavoring agents.

Advantageously, the cocoa composition of the present invention will be a chocolate composition. Although it should not be interpreted as being limited to any particular legal definitions, in one aspect, the cocoa composition of the invention will be a chocolate product as defined in Directive 2000/36/EC of the European Parliament and of the Council of 23 Jun. 2000.

The term “cocoa solids” as used herein may refer to any component derived from cocoa beans such as, but not limited to, cocoa liquor, cocoa powder and/or cocoa butter. The cocoa composition of the present invention will preferably comprise at least 2 weight %, more preferably at least 5 weight %, more preferably at least 10 weight %, more preferably at last 15 weight % cocoa solids. In one aspect, the composition of the present invention will comprise cocoa solids in an amount of at least 30 weight %, preferably more than 30 weight %, preferably at least 33 weight %, more preferably at least 35 weight %. In one aspect, the composition of the invention will comprise 30-95 weight %, preferably 30-75 weight %, more preferably 30-55 weight % cocoa solids. Alternatively, the composition may comprise less than 30 weight % cocoa solids, for instance 2-30 weight %, 5-25 weight %, or 10-20 weight %.

Cocoa liquor, also called “cocoa mass”, is produced from ground cocoa beans. Prior to or after grinding, the beans may be fermented, dried, roasted, alkalized and/or treated using any other technique known in the art. The cocoa composition of the present invention will preferably comprise 5-30 weight %, more preferably 10-25 weight %, more preferably 15-25 weight %, more preferably 18-22 weight % cocoa liquor.

Cocoa butter is the fat extracted from cocoa beans, typically by pressing the cocoa liquor. Cocoa butter may be deodorized to remove strong or undesirable tastes. Advantageously, the composition will include not less than 18 weight %, preferably not less than 20 weight %, more preferably not less than 25 weight % cocoa butter and/or cocoa butter alternatives. Indeed, cocoa butter may be replaced, in whole or in part, by cocoa butter alternatives. Cocoa butter alternatives are well known in the art and include cocoa butter replacers, cocoa butter equivalents, cocoa butter improvers, and cocoa butter substitutes. They are typically vegetable fats and/or vegetable fat fractions with similar physical or chemical properties to cocoa butter.

Cocoa powder is produced by further grinding or milling the “dry” residue obtained from cocoa liquor after pressing. It may be natural cocoa powder, with a pH of around 5.5, or it may be processed (e.g. treated with alkali or acid). It may have a relatively high fat content, e.g. above 15 weight % residual cocoa butter, a standard fat content (e.g. 10-15 weight % cocoa butter), or a low fat content (less than 10 weight % cocoa butter). Fat-free cocoa powders may also be used (e.g. with a fat content of less than 2 weight %).

The cocoa composition according to the present invention comprises milk solids in an amount of less than 5 weight %, preferably in an amount of less than 4 weight %, more preferably less than 3 weight %, more preferably less than 2 weight %, more preferably less than 1 weight %. Milk solids according to the present invention may be defined as any dry component derived from milk such as, but not limited to, milk fat or fractions thereof, lactose, skimmed or whole milk powder, whey, whey powder, caseinate, and/or milk hydrolysate. As used herein, “milk” refers to milks of mammalian origin (e.g. non-human milks such as cow, buffalo, sheep, and/or goat milk). In one aspect, the cocoa composition of the invention will be substantially free of milk solids.

What's more, although they may be used to produce foodstuffs comprising fillings or inclusions, the cocoa compositions themselves will not include such components. Indeed, the compositions of the invention will preferably be homogenous (or “continuous”) cocoa compositions, i.e. with a consistent texture and structure throughout. The compositions of the invention will also preferably be carob-free. Advantageously, they may also be free of soy protein.

The cocoa compositions will preferably be moldable compositions. As used herein, the term “moldable” refers to a composition that is capable of being formed into a shape in a mold, setting (preferably at room temperature), and then retaining the molded shape after removal of the mold. Thus, the compositions of the invention will preferably not be in the form of a powder or of a particulate material. Furthermore, the compositions of the present invention will preferably have a water content of less 10% by weight based on the total weight of the composition. More preferably, they will have a water content of less 5%, more preferably less than 3%, more preferably less than 2%, and more preferably less than 1% by weight.

### Pea Protein

The cocoa composition according to the invention is further characterized in that it comprises 0.5-15 weight %, preferably 1-10 weight %, more preferably 2-5 weight % pea protein.

Pea protein may be present in the cocoa composition in the form of pea protein isolate, pea protein concentrate, whole pea powder, extruded micronized pea powder, hydrolyzed pea protein or the like. It may also be roasted (e.g. in the form of roasted pea powder) prior to use. Concentrates and pea protein isolates are defined in terms of their protein content. “Pea protein concentrates” have a total protein content of 60 to 75% on a dry weight basis, while “pea protein isolates” have a total protein content of 90 to 95% on a dry weight basis. “Pea protein hydrolysates” are preparations obtained by enzymatic and/or chemical hydrolysis of pea protein. Protein hydrolysates consist of a mixture of peptides of different sizes and free amino acids.

Preferably, no protein other than pea protein will be present in the composition of the invention except for possible trace amounts of protein incidentally introduced as part of other ingredients e.g. as part of the plasticizer or the cocoa solids. In calculating the total protein content of the cocoa composition, these incidental protein inclusions, and in particular any cocoa protein, will be discounted. Thus, the total protein content of the composition of the invention will be considered to be the total pea protein content of the composition.

### Plasticizer Ingredient

The cocoa composition of the invention comprises 0.5-10 weight % of a plasticizer ingredient. Preferably, the plasticizer ingredient will be present in the cocoa composition in an amount from 1.0 to 9 weight %, more preferably from 1.5 to 8 weight %, more preferably from 2 to 7 weight %, more preferably from 2.5 to 6 weight %.

Without wishing to be bound by theory, it is believed that the plasticizer ingredient will perform, at least in part, a comparable function in the cocoa composition of the invention to milk fat in a traditional milk chocolate. In particular, it has been found that the plasticizer ingredient will result in the cocoa composition having a less brittle structure and a more creamy mouthfeel.

In one aspect of the invention the plasticizer ingredient may be a liposoluble ingredient from a vegetable source, including vegetable fats and oils. Preferably, the plasticizer will be a vegetable fat or oil (such as palm or palm kernel oil, or shea butter) with a melting point below that of cocoa butter. More preferably, it will be selected from the group consisting of liquid oils, randomized fats and combinations of two or more thereof.

Liquid oils are oils that remain liquid at room temperature. The liquid oils used in accordance with the present invention will preferably be vegetable liquid oils, that is, liquid oils from a vegetable source. Suitable vegetable sources include, by way of example only, almonds, pine nuts, pistachios, cashews, hazelnut, peanuts, sesame seeds, sunflower seeds, high-oleic sunflower seeds, rapeseeds or mixtures of two or more thereof. They may also include specific varieties of cocoa beans that produce particularly soft cocoa butter such as Brazilian cocoa bean. When using such “soft” cocoa beans as plasticizers, both cocoa butter and/or cocoa liquor may be used. These will then also contribute cocoa solids to the overall composition.

The oils may be used as such—that is as oils extracted through pressing or other known methods from their source—or they may be incorporated into the cocoa composition in the form of a paste produced by grinding the source (e.g. a nut paste). Preferably the liquid oil will be present in the cocoa composition in an amount of 0.5 to 5 weight %, more preferably in an amount of 0.5 to 3 weight %, more preferably from 1 to 2 weight %. When incorporated in the form of a paste, sufficient paste will be added to achieve the preferred liquid oil content(s) as specified above.

In a specific aspect of the present invention, the plasticizer ingredient will comprise or consist of almond oil and/or hazelnut oil which will advantageously be added to the cocoa composition in the form of an almond and/or hazelnut paste.

The plasticizer ingredient may also comprise or consist of randomized fats. The term “randomized fat” as used herein refers to triglyceride compositions comprising long chain and/or short chain fatty acids that are randomly distributed over the glycerol backbones of the triglycerides. Long chain fatty acids are defined as fatty acids with 16 to 24 carbon atoms. Short chain fatty acids are defined as fatty acids with 4 to 14 carbon atoms. The ratio between long chain and short chain fatty acids in the randomized fats may range from 20/80 up to 80/20. Preferably, the ratio will be from 30/70 to 70/30, more preferably from 40/60 to 60/40. Alternatively, the triglyceride composition of the randomized fat may consist only of long chain fatty acids that are randomly distributed over the triglyceride backbone. These long chain fatty acids may be saturated fatty acids (S) or unsaturated fatty acids (U). Randomized fats may be obtained by chemical and/or enzymatic interesterification or by any other method available to a person skilled in the art. Randomization may be complete or partial. A partially randomized fat is a fat which has not been allowed to react to achieve its fully converted state for a given set of reaction conditions.

In one aspect of the present invention, the randomized fat may be a randomized cocoa butter. Randomized cocoa butter may be obtained by chemical or enzymatic interesterification. It may also be obtained by deodorizing the cocoa butter for a long time (1 to 4 hours) at extremely high temperatures (above 235° C.).

Preferably the randomized fat will be present in the cocoa composition in an amount of 0.5 to 5 weight %, more preferably in an amount of 0.5 to 3 weight %, more preferably from 1 to 2 weight %.

Advantageously, liquid oils and/or randomized fats used in accordance with the present invention will not comprise any hydrogenated fat. Preferably, the plasticizer ingredient will not comprise any hydrogenated fat.

Preferably, emulsifiers such as lecithin and/or PGPR will not be used as plasticizers. Thus, the plasticizer ingredient will preferably be present in addition to any such emulsifiers.

### Bulking Ingredient

The cocoa composition of the present invention may also comprise a bulking ingredient. The bulking ingredient will preferably be included in an amount of 0.5 to 15 weight %, preferably in an amount of 2 to 12 weight %, more preferably in an amount of 4 to 10 weight %. The bulking agent may be selected from the group consisting of oligosaccharides, polysaccharides, soluble dietary fibres, insoluble dietary fibres and mixtures of two or more thereof.

Oligosaccharides are saccharide polymers containing a small number (typically three to ten) monosaccharides. Suitable oligosaccharides for use in the present invention include fructo-oligosaccharides (FOS). FOS are short chains of fructose molecules found in many vegetables. They are considered soluble dietary fibres. Another type of suitable oligosaccharides is galacto-oligosaccharides (GOS), which also occur naturally. They consist of short chains of galactose molecules. These compounds, acting as soluble dietary fibres, cannot be digested in the human small intestine and instead pass through to the large intestine, where they promote the growth of Bifidobacteria, which are beneficial to gut health.

Suitable polysaccharides include glucose polymers such as starch, and starch-derivatives such as glucose syrup, maltodextrin and dextrin. Fructans and inulin are further examples of suitable polysaccharides. These are polymers of fructose with a much higher degree of polymerization than FOS. They are also considered soluble dietary fibres. Another example of soluble fibre suitable for use in the present invention is polydextrose which is obtained by thermal polymerisation of dextrose. Suitable polysaccharides may also include agar, galactomannans such as guar gum, locust bean gum, and amylopectins, pectin and combinations of two or more of the above.

Suitable insoluble fibres may be selected from the group consisting of resistant starches, cereal fibres, fruit fibres, fibres of legumes and mixtures of two or more thereof.

Preferably, the bulking ingredient will be selected from the group consisting of vegetable fibres, dextrin, maltodextrin, polydextrose, inulin, dehydrated grain syrups (such as dried rice syrup), pectin, and mixtures of two or more thereof.

Alternatively, the bulking agent will include or consist of vegetable fibres selected from the group consisting of cereal and grain fibres, fruit fibres and mixtures of two or more thereof, preferably rice fibres, pea fibres, coconut fibres, soy fibres and mixtures of two or more thereof.

The cocoa composition of the present invention may also comprise other ingredients such as emulsifiers and/or flavourings. Emulsifiers suitable for use in the present invention will be well known to a person skilled in the art and may include, by way of example only, lecithin, PGPR and/or variants thereof such as hydrolysed or PC-enriched (or phosphatidylcholine-enriched) lecithin. Flavourings may include, but are not limited to, vanilla flavour, vanillin, caramel flavour and the like.

### Sweeteners

The cocoa composition will preferably include one or more sweeteners. These may be selected from caloric sweeteners such as sucrose and/or non- or low-caloric sweeteners. Non- and low-caloric sweeteners include, without limitation, high intensity sweeteners such as aspartame, saccharin, and steviol glycosides, and sugar alcohols. Sugar alcohols (also called polyols), include amongst others sorbitol, mannitol, xylitol, maltitol, maltitol syrup, lactitol, erythritol, isomalt and hydrogenated starch hydrolysates. Preferably, the cocoa composition will not include maltitol, lactitol, and/or erythritol in an amount of more than 30 weight %, more preferably not in an amount of more than 20 weight %, more preferably not in an amount of more than 10 weight %, more preferably not in an amount of more than 5 weight %. Advantageously, it will contain substantially no maltitol, lactitol, and/or erythritol. In one aspect, it will not include any sugar alcohols. In another aspect, the composition will not include any high intensity sweeteners. In another aspect, it will not include any non- or low-caloric sweeteners.

Preferably, the sweetener will consist of sucrose. The amount of sucrose in the cocoa composition will preferably be at least 30 weight %, more preferably at least 30.5 weight %, more preferably at least 32 weight %, more preferably at least 35 weight %.

In one aspect of the invention the cocoa composition comprises at least 30 weight % of cocoa solids and less than 0.2 weight % of milk solids, characterized in that it further comprises 0.5-15 weight % pea protein, 0.5-10 weight % of a plasticizer ingredient and at least 30 weight % of sucrose.

In another aspect of the invention, the cocoa composition comprises at least 30 weight % of cocoa solids and less than 2 weight % of milk solids, characterized in that it further comprises 0.5-15 weight % pea protein and 0.5-5 weight % of a liquid oil and/or a randomized cocoa butter.

In yet another aspect of the invention, the cocoa composition comprises at least 30 weight % of cocoa solids and less than 2 weight % of milk solids, characterized in that it further comprises 0.5-15 weight % pea protein, 3-8 weight % maltodextrin and 2-5 weight % of a liquid oil and/or a randomized cocoa butter.

Advantageously, the cocoa composition according to the invention shows very similar properties to milk chocolate. Along with the cocoa butter, milk solids are responsible for some of the most important properties of milk chocolate products. These properties include its sensory qualities, it's (creamy mouth feel and snap, for instance, or its quicker melting behavior compared to dark chocolate. It was found that the cocoa composition according to the invention, although not brittle, maintains the desired snappy effect when broken or bitten into.

Additionally, it was found to have a creamy eating sensation that is comparable to that of milk chocolate.

The cocoa composition of the present invention can be produced by any conventional method for making chocolate known to the skilled person. The cocoa solids and other ingredients of the cocoa composition according to the invention are mixed, ground and conched substantially in the same manner one would produce chocolate, using any methods known to those of skill in the art of chocolate making. Once the cocoa composition is processed, it can be placed in molds, or otherwise formed or applied in and/or onto food products as is known in the art.

### Food Products

As such, the present invention further relates to food products comprising cocoa compositions as described herein. These food products will preferably be bakery products and/or confectionary products but could also include other dairy-free or dairy-reduced food products (termed “dairy alternative” products).

A “bakery product” can be defined as any food product wherein flour is used to produce a dough or a batter. Examples of bakery products are, without limitation, breads such as bagels, buns, rolls, biscuits and loaf breads; cookies; brownies; muffins; desserts such as cakes, cheesecakes and pies; snack cakes; sweet goods such as doughnuts, Danish, sweet rolls, cinnamon rolls and coffee cake.

A “confectionary product” is a food item that is rich in sugar. Confectionary products may be amongst others candies, candied nuts, candy bars, caramels, chocolates, chocolate bars, chocolate drops, chocolate in the form of hollow figures or any desired shape, filled chocolate bars, pralines, truffles, cereal bars, chewing gum, pastillage, and other confections that are made primarily of sugar.

A “dairy-alternative” product is an alternative for products traditionally based on milk such as but not limited non-dairy beverages; frozen desserts like ice cream; and other chilled desserts; non-dairy alternatives for cultured dairy such as yoghurt, cream and fresh or cream cheeses; and dairy alternatives for custard-based desserts.

Cocoa compositions of the invention may be used in food products in any form such as melted and mixed into the recipe of the end product, in the form of fillings, inclusions, toppings or coatings, molded around other discrete ingredients such as nuts, fruit, dried fruit, biscuits or biscuit pieces, candy pieces or shapes, and the like, or any combination of two or more thereof. Thus, the present invention also relates to bakery products, confectionery products, and frozen or chilled desserts comprising the chocolate compositions of the present invention as a filling, inclusion, topping and/or coating, and to confectionery products comprising the chocolate compositions of the present invention together with one or more discrete ingredients.

### EXAMPLES

A number of samples (1-14) were prepared using the recipes shown in Table 1, below. The ingredients used are described in Table 2.

The dry ingredients (including any bulking agents and vegetable protein ingredients), the cocoa liquor and a part of the cocoa butter were mixed together for 10 minutes in a Hobart mixer at a temperature of 45 to 50° C. The cocoa butter addition was adapted on a case-by-case basis to get a correct texture for refining. Optimal fat content in the mixer was 25-26%.

The resulting chocolate paste was then refined in a Bühler three roll refiner, in order to produce refiner flakes having a reduced particle size between 18 and 24 μm.

The refiner flakes were then dry-conched for 6 hours at a temperature of 65° C. in a 5 kg batch Bühler Elkolino monoshaft conche running clockwise at a rotor speed of 1000 rpm. Additional cocoa butter was added when needed during the filling of the conche, in order to ensure a proper mechanical shearing and a good flavour development. At the end of the dry conching, any remaining cocoa butter and PGPR was added to the conche. The mixture was then wet-conched for 30 min at 1500 rpm counter-clockwise at a temperature of 45° C. The chocolate mass was then unloaded.

Plasticizer ingredients were added into the chocolate mass manually in a bucket after conching to avoid contaminating the conching equipment with potential allergens like e.g. nuts. If necessary, viscosity and yield value of the resulting chocolate were adjusted by adding further cocoa butter and/or emulsifiers (resulting in the total amounts indicated in Table 1).

After adjustment of the rheology, the chocolate underwent a hand tempering process and was moulded into bars. Tempering involves the controlled heating and cooling of the mixture to selectively cause the crystallisation of the cocoa butter in the preferred crystalline form V.

Several of the obtained chocolates were then analysed to determine viscosity, yield value and colour using the methods described below. The results are shown in Table 3.

### Analytical Methods

### Particle Size

A small amount of finished chocolate is placed on the measuring surface of a Mitutoyo micrometer (0-25 mm). By pressing, an indication of the size of the largest non-compressible particles can be measured.

### Colour

Color values are expressed as Hunter L, -a and -b values, where the L value represents the “brightness” of the product (black/white scale), the “a” value represents the amount of green/red and the “b” value represents the amount of yellow/blue. The quotient of “a” over “b” represents the redness of the product. The following procedure is used to determine the color value of chocolate.

A small amount of chocolate at 50° C. is poured into an optically neutral petri dish (diameter 55 mm) right to the top. The petri dish is then placed on a calibrated spectrocolorimeter Minolta CM2500D (Illuminant D65, 10° observer, read values in Hunter L -a and b values, software Minolta SPECTRA MAGIC version 1.00). The L, a and b-values of the chocolate sample are then measured and recorded following the manufacturer's instructions.

### Flow Properties

The flow behaviour of the chocolate is measured by the ICA-Method 46—2000-Viscosity of Cocoa and Chocolate Products using a rheometer RM200 (Lamy Rheology Instruments, Champagne au Mont d'Or, France). It is a shear-rate imposed rheometer whereby its speed ranges from 0.3 to 1500 rpm and the torque from 0.05 to 30 mNm. The temperature of the measuring cell is kept at 40° C. A small amount of chocolate is brought into the tube. After pre-shearing the chocolate for 10 min at 5s-1, a stepped flow procedure is applied by increasing and decreasing the shear rate while measuring the shear stress. The Casson model is used to define Casson Yield stress and Casson Viscosity for recipes with a fat content below 38%. For recipes with a fat content higher than 38% a polynomial model is used.

TABLE 1
Recipes

| Ingredients (%)/Sample no. | 1 | 2 | 3 |
|---|---|---|---|
| WAF Cocoa Liquor | 19.55 | | 19.56 |
| WAF Cocoa Butter | 32.42 | | 32.44 |
| Soft cocoa butter | | 33.12 | |
| Soft cocoa liquor | | 20.23 | |
| Sugar | 37.29 | 38.59 | 37.31 |
| Pea proteins | 2.86 | 2.96 | 2.86 |
| Pea fibers | | | 4.1 |
| Maltodextrin | 4.10 | 4.24 | |
| Almond paste | 2.86 | | 2.86 |
| Vanillin | 0.01 | 0.01 | 0.01 |
| PGPR | 0.05 | 0.05 | 0.05 |
| Soy lecithin | 0.86 | 0.79 | 0.79 |
| TOTAL (%) | 100 | 100 | 100 |
| Theoretical fat content (%) | 45.24 | 44.89 | 45.40 |

TABLE 2
Ingredients

| Ingredient Name | Ingredient Detail/Origin | Function |
|---|---|---|
| WAF Cocoa Liquor | Rain Forest Alliance West African | Cocoa Solids |
| | cocoa liquor/Cargill | |
| WAF Cocoa Butter | Rain Forest Alliance West African | Cocoa Solids |
| | cocoa butter/Cargill | |
| Sugar | Standard icing sugar | Sweetener |
| Pea proteins | Pea protein isolates Pisane ® B9/Cosucra | Protein |
| Soft cocoa butter | Brazilian soft deodorized | Plasticizer + |
| | cocoa butter/Cargill | Cocoa Solids |
| Soft cocoa liquor | Brazilian soft deodorized | Plasticizer + |
| | cocoa liquor/Cargill | Cocoa Solids |
| Almond paste | Almond milk paste/Di Bartolo | Plasticizer |
| Pea fibers | Pea fibre Swelite ®/Cosucra | Bulking Agent |
| Maltodextrin | Maltodextrin C Dry ™ MD01915/Cargill | Bulking Agent |
| Vanillin | Vanillin/Prova | Flavor |
| PGPR | Polyglycerol polyricinoleate | Emulsifier |
| | Radiamuls Poly 2253K/Oleon | |
| Soy lecithin | Soya lecithin Epikuron 135 F IP/Cargill | Emulsifier |

TABLE 3
Measurements

| Sample | 1 | 3 |
|---|---|---|
| Viscosity | 0.359 | 0.36 |
| Yield Value | 1.46 | 1.64 |
| L | 38.73 | 39.76 |
| a | 8.86 | 9.05 |
| b | 10.39 | 11.15 |

1. A cocoa composition comprising less than 5 weight % of milk solids, characterized in that it comprises 0.5-15 weight % of a pea-based protein and 0.5-10 weight % of a plasticizer ingredient.

2. The cocoa composition according to claim 1, characterized in that the pea-based protein is selected from the group consisting of whole pea powder, a pea protein isolate, a pea protein concentrate, a pea protein hydrolysate, and a combination of two or more thereof.

3. The cocoa composition according to claim 1, characterized in that the plasticizer ingredient is a liposoluble ingredient.

4. The cocoa composition according to claim 3, characterized in that the liposoluble ingredient is selected from the group consisting of liquid oil, randomized fats, and combinations of two or more thereof.

5. The cocoa composition according to claim 4, characterized in that the liposoluble ingredient is substantially free from hydrogenated fats.

6. The cocoa composition according to claim 4, characterized in that the liquid oil is selected from the group consisting of oils sourced from almonds, pine nuts, pistachios, cashews, hazelnuts, peanuts, sesame seeds, sunflower seeds, high-oleic sunflower seeds, rapeseeds, and mixtures of two or more thereof.

7. The cocoa composition according to claim 1, characterized in that the composition further comprises a bulking ingredient selected from the group consisting of oligosaccharides, polysaccharides, soluble dietary fibres, insoluble dietary fibres, and mixtures of two or more thereof.

8. The cocoa composition according to claim 7, characterized in that the bulking ingredient is selected from the group consisting of vegetable fibres, dextrin, maltodextrin, polydextrose, inulin, dehydrated grain syrups, pectin, and mixtures of two or more thereof.

9. The cocoa composition according to claim 8, characterized in that the vegetable fibres are selected from the group consisting of cereal or grain fibres, fruit fibres, and mixtures of two or more thereof.

10. The cocoa composition according to claim 1, characterized in that it comprises at least 30 weight % of sucrose.

11. The cocoa composition according to claim 1, characterized in that it comprises at least 30 weight % of cocoa solids.

12. The cocoa composition according to claim 1, characterized in that it is substantially free from milk solids.

13. The cocoa composition according to claim 1, characterized in that it comprises less than 30 weight % maltitol, erythritol and/or lactitol.

14. Food products comprising the cocoa composition according to claim 1, characterized in that the food products are selected from the group consisting of bakery products, confectionary products, and dairy-alternative products.

15. The cocoa composition according to claim 1, characterized in that the plasticizer ingredient is a liposoluble ingredient and is from a vegetable source.

16. The cocoa composition according to claim 8, characterized in that the vegetable fibres are selected from the group consisting of rice fibres, pea fibres, coconut fibres soy fibres, and mixtures of two or more thereof.
